(19) United States
(12) Patent Application Publication
(10) Pub. No.: US 2026/0245287 A1
(43) Pub. Date: Aug. 20, 2026

(54) THREE -DIMENSIONAL IMAGE GENERATION

(71) Applicant: Tencent Technology (Shenzhen) Company Limited, Shenzhen (CN)

(72) Inventors: Shijie ZHANG, Shenzhen (CN); Chengming XU, Shenzhen (CN); Junwei ZHU, Shenzhen (CN); Xuelin QIAN, Shenzhen (CN); Ying TAI, Shenzhen (CN); Yanwei FU, Shenzhen (CN); Chengjie WANG, Shenzhen (CN)

(73) Assignee: Tencent Technology (Shenzhen) Company Limited, Shenzhen (CN)

(21) Appl. No.: 19/643,757

(22) Filed: Apr. 9, 2026

Related U.S. Application Data
(63) Continuation of application No. PCT/CN2025/071244, filed on Jan. 8, 2025.

(30) Foreign Application Priority Data
Jan. 12, 2024 (CN) 202410051143.9

(51) Int. Cl. G06T 15/04; G06F 40/40; G06T 13/40

(52) U.S. Cl. CPC G06T 15/04; G06F 40/40; G06T 13/40

(57) ABSTRACT

In a three-dimensional image generation method, a text prompt describing an object is received. A geometric shape model of the object is generated based on the text prompt through a shape generator. A modified text prompt is obtained based on a combination of an average texture token and the text prompt, the average texture token corresponding to common texture information of a category of the object. In the method, a texture parameter set of the object is generated based on the modified text prompt through a texture generator. In the method, a three-dimensional image of the object is generated by processing circuitry based on mapping texture information indicated by the texture parameter set to the geometric shape model. Electronic device and non-transitory computer-readable storage medium counterparts are also contemplated.

### RELATED APPLICATIONS

The present application is a continuation of International Application No. PCT/CN2025/071244, filed on Jan. 8, 2025, which claims priority to Chinese Patent Application No. 202410051143.9, filed on Jan. 12, 2024, and entitled “THREE-DIMENSIONAL IMAGE GENERATION METHOD AND APPARATUS. The entire disclosures of the prior applications are hereby incorporated by reference.

### FIELD OF THE TECHNOLOGY

The present disclosure relates to the field of artificial intelligence, including three-dimensional image generation methods and apparatuses, electronic devices, and non-transitory computer-readable storage media.

### BACKGROUND OF THE DISCLOSURE

Artificial intelligence (AI) may correspond to a theory, a method, a technology, and an application system that use a digital computer or a machine controlled by the digital computer to simulate, extend, and expand human intelligence, perceive an environment, acquire knowledge, and use knowledge to obtain a result. Basic artificial intelligence technologies may include technologies such as a sensor, a dedicated artificial intelligence chip, cloud computing, distributed storage, a big data processing technology, a pre-training model technology, an operating/interaction system, and electromechanical integration. A pre-training model may be referred to as a large model or a basic model, and after fine-tuning, may be applied to downstream tasks in various implementations of artificial intelligence. Artificial intelligence software technologies may include several applications such as a computer vision (CV) technology, a speech processing technology, a natural language processing technology, and machine learning/deep learning.

The computer vision technology attempts to establish an artificial intelligence system that may acquire information from an image or multi-dimensional data. Large model technologies have brought about significant transformations in development of the computer vision technology. Pre-training models in a vision field, such as swin-transformer, ViT, V-MOE, and MAE, may be rapidly and widely applied to specific downstream tasks after fine-tuning. The computer vision technology may include technologies such as image processing, image recognition, image semantic understanding, image retrieval, optical character recognition (OCR), video processing, video semantic understanding, video content/behavior recognition, three-dimensional (3D) object reconstruction, 3D technologies, virtual reality, augmented reality, simultaneous localization and mapping, and may further include common biometric recognition technologies such as facial recognition and fingerprint recognition.

With development of digital entertainment industries such as gaming and audiovisual media, the computer vision technologies like virtual reality and augmented reality have been increasingly applied, with implementation highly relying on three-dimensional data resources, especially on a three-dimensional portrait. Therefore, how to generate a high-quality three-dimensional image has also been a research hotspot in the field of computer vision technologies.

### SUMMARY

The present disclosure provides three-dimensional image generation methods and apparatuses, electronic devices, non-transitory computer-readable storage media, and computer program products.

According to one aspect of the present disclosure, a three-dimensional image generation method is provided. In the method, a text prompt describing an object is received. A geometric shape model of the object is generated based on the text prompt through a shape generator. A modified text prompt is obtained based on a combination of an average texture token and the text prompt, the average texture token corresponding to common texture information of a category of the object. In the method, a texture parameter set of the object is generated based on the modified text prompt through a texture generator. In the method, a three-dimensional image of the object is generated by processing circuitry based on mapping texture information indicated by the texture parameter set to the geometric shape model.

According to one aspect of the present disclosure, an electronic device is provided. The electronic device includes processing circuitry configured to receive a text prompt describing an object. The processing circuitry is configured to generate a geometric shape model of the object based on the text prompt through a shape generator. The processing circuitry is configured to obtain a modified text prompt based on a combination of an average texture token and the text prompt, the average texture token corresponding to common texture information of a category of the object. The processing circuitry is configured to generate a texture parameter set of the object based on the modified text prompt through a texture generator. The processing circuitry is configured to generate a three-dimensional image of the object based on mapping texture information indicated by the texture parameter set to the geometric shape model.

According to one aspect of the present disclosure, a non-transitory computer-readable storage medium is provided. The non-transitory computer-readable storage medium stores instructions, which when executed by a processor, cause the processor to perform a three-dimensional image generation method. In the method, a text prompt describing an object is received. A geometric shape model of the object is generated based on the text prompt through a shape generator. A modified text prompt is obtained based on a combination of an average texture token and the text prompt, the average texture token corresponding to common texture information of a category of the object. In the method, a texture parameter set of the object is generated based on the modified text prompt through a texture generator. In the method, a three-dimensional image of the object is generated based on mapping texture information indicated by the texture parameter set to the geometric shape model.

According to one aspect of the present disclosure, a three-dimensional image generation method is provided, including: receiving a text prompt describing an object; generating a geometric shape model of the object from the text prompt through a shape generator; combining an average texture token into the text prompt, to obtain a modified text prompt, the average texture token representing common texture information of a category of the object; generating a texture parameter set of the object from the modified text prompt through a texture generator; and generating a three-dimensional image of the object based on the geometric shape model and the texture parameter set.

According to another aspect of the present disclosure, a three-dimensional image generation apparatus is provided. The apparatus includes: an input unit, configured to receive a text prompt describing an object; a shape generation unit, configured to generate a geometric shape model of the object from the text prompt through a shape generator; a texture generation unit, configured to combine an average texture token into the text prompt, to obtain a modified text prompt, the average texture token representing common texture information of a category of the object, and generate a texture parameter set of the object from the modified text prompt through a texture generator; and an output unit, configured to generate a three-dimensional image of the object based on the geometric shape model and the texture parameter set.

According to another aspect of the present disclosure, an electronic device is provided, including: one or more processors, and one or more memories, the memory including a non-transitory computer-readable storage medium with instructions stored therein, and the instructions, when executed by the one or more processors, causing the one or more processors to perform the method according to the foregoing aspects.

According to another aspect of the present disclosure, a non-transitory computer-readable storage medium is provided, having instructions stored therein, the instructions, when executed by processing circuitry (e.g., a processor), causing the processing circuitry to perform the method according to any one of the foregoing aspects of the present disclosure.

According to another aspect of the present disclosure, a computer program product is provided, including a non-transitory computer-readable storage medium with instructions stored therein, the instructions, when executed by processing circuitry (e.g., a processor), causing the processing circuitry to perform the method according to any one of the foregoing aspects of the present disclosure.

### BRIEF DESCRIPTION OF THE DRAWINGS

By describing embodiments of the present disclosure in further detail with reference to accompanying drawings, the foregoing and other objectives, features, and advantages of the present disclosure will be illustrated. The accompanying drawings are used to provide a further understanding of one or more embodiments of the present disclosure, and constitute a part of this disclosure, which are used to explain the present disclosure in conjunction, and do not constitute a limitation to the present disclosure. In the accompanying drawings, same reference numerals may represent the same components or operations.

FIG. 1 is a scenario diagram of a three-dimensional image generation system according to an embodiment of the present disclosure.

FIG. 2 is a flowchart of a three-dimensional image generation method according to an embodiment of the present disclosure.

FIG. 3 is a flowchart of a method for training a shape generator according to an embodiment of the present disclosure.

FIG. 4 is a flowchart of a method for training a texture generator according to an embodiment of the present disclosure.

FIG. 5 is a training data generation process according to an example of an embodiment of the present disclosure.

FIG. 6 is a process of training a shape generator and a texture generator according to an embodiment of the present disclosure.

FIG. 7 is a schematic processing process of a three-dimensional image generation model according to an example of an embodiment of the present disclosure.

FIG. 8 is a schematic structural diagram of a three-dimensional image generation apparatus according to an embodiment of the present disclosure.

FIG. 9 is a schematic diagram of an architecture of a computing device according to an embodiment of the present disclosure.

### DETAILED DESCRIPTION

Descriptions of terms in this disclosure are provided as examples only and are not intended to limit the scope of the disclosure.

Technical solutions in the present disclosure are described below in conjunction with accompanying drawings. One or more embodiments described in this disclosure are some embodiments rather than all the embodiments of the present disclosure. Other embodiments obtained by those of ordinary skill in the art based on the present disclosure shall fall within the scope of the present disclosure.

As shown in the embodiments and the claims of the present disclosure, words such as “a/an”, “one”, “one kind”, and/or “the” do not refer specifically to singular forms and may also include plural forms, unless the context expressly indicates otherwise. The “first”, the “second”, and similar terms used in the present disclosure are used to distinguish different components instead of representing any sequence, quantity, or importance. Similarly, “include”, “contain”, or similar terms mean that elements or items appearing before the term cover elements or items listed after the term and their equivalents, but do not exclude other elements or items. “Connect”, “link”, or similar terms are not limited to a physical or mechanical connection, but may include an electrical connection, whether direct or indirect.

In aspects of this disclosure, the term “module” or “unit” may refer to a computer program with a preset function or a part of the computer program, works, together with other related parts, to implement a preset target, and may be implemented using software, hardware (e.g., processing circuitry or a memory), or a combination thereof. Similarly, one processor (or a plurality of processors or memories) may be configured to implement one or more modules or units. In addition, each module or unit may be a part of an overall module or unit including a function of the module or unit.

In the present disclosure, references to “at least one of A, B, or C” or “one or more of A, B, or C” are intended to include any one or a combination of the recited elements. For example, “at least one of A, B, or C” includes A alone, B alone, C alone, A and B, A and C, B and C, or A, B, and C together. Similarly, “one of A or B” includes A, B, or both.

In addition, flowcharts are used in the present disclosure for illustrating operations performed by the system according to one or more embodiments of the present disclosure. The foregoing or following operations are not necessarily performed according to an order. On the contrary, various operations may be performed in a reverse order or simultaneously. Meanwhile, other operations may also be added to the processes. Alternatively, one or more operations may be deleted from the processes.

In recent years, a computer vision technology has developed rapidly, with a three-dimensional modeling technology remaining a research hotspot, especially in the AI generated content (AIGC). The AIGC may be implemented using a large model. The large model may refer to a neural network model including ultra-large-scale parameters (e.g., one billion or more), has a strong expression capability and learning capability, but also needs substantial amounts of data and computing resources for training, leading to development of pre-training models. The pre-training model may refer to a deep neural network (DNN) with a large number of parameters. The pre-training model is trained on a substantial amount of unmarked data to learn a universal feature representation, and may be applicable to various downstream tasks by using technologies such as fine tuning, parameter-efficient fine-tuning (PEFT), and prompt-tuning. Therefore, the pre-training model may achieve an ideal effect in a few-shot or zero-shot scenario. The pre-training model is an important tool for outputting the AIGC, and may also be used as a general interface for connecting a plurality of specific task models.

The AIGC may be implemented based on a diffusion model that generates an image from text. The diffusion model may include a forward process and a reverse process. In the forward process, random noise is added to an image, and in the reverse process, the image is restored from a noise-added image. To address a speed bottleneck of the diffusion model, a latent diffusion model (LDM) converts image processing from a pixel space into a latent space with a small dimension, thereby improving training efficiency. A typical example is a stable diffusion model. In 2022, Google released a DreamFusion model, which may generate a 3D object from text, and a training strategy called score distillation sampling (SDS) was introduced, thereby facilitating a design of text-to-3D object models and providing a foundation for subsequent scientific research.

A related text-to-3D object model is usually based on a pre-trained diffusion model, and uses the SDS technology to independently optimize shape and texture information of a three-dimensional object. Although these SDS-based methods may generate good three-dimensional static objects, the related methods may have the following limitations: (1) a large quantity of training data sets may need to be collected for model training, resulting in high training costs; (2) some methods may require a significant number of iterations to optimize for each text prompt, consuming a substantial amount of time when generating 3D objects; and (3) some methods may rely on an implicit representation, but the implicit representation may not directly reflect geometric shape information of the three-dimensional objects, may lack control on an element such as a skeletal structure or a facial expression, and as a result, may not be applicable to animation.

For the foregoing problem, the present disclosure provides a three-dimensional image generation model and a three-dimensional image generation method based on the model. A data-free training method is used, thereby directly generating training data without collecting a large-scale training data set, and a three-dimensional image suitable for animation may be generated at a high speed.

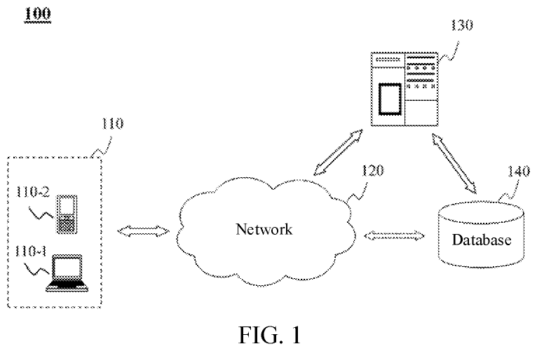

FIG. 1 is a scenario diagram of a three-dimensional image generation system according to an embodiment of the present disclosure. As shown in FIG. 1, the three-dimensional image generation system 100 may include a user terminal 110, a network 120, a server 130, and a database 140.

The user terminal 110 may be, for example, a computer 110-1 and a mobile phone 110-2 shown in FIG. 1. The user terminal 110 may be any other type of electronic device capable of performing data processing, and may include, but is not limited to, a fixed terminal such as a desktop computer and a smart television, a mobile terminal such as a smartphone, a tablet computer, a portable computer, and a handheld device, or any combination thereof. This embodiment of the present disclosure does not impose specific limitations on this.

The user terminal 110 according to this embodiment of the present disclosure may be configured to receive a text prompt, and generate a three-dimensional image of an object based on the text prompt by using a three-dimensional image generation method according to the present disclosure. In some embodiments, a processing unit of the user terminal 110 may be used to perform the three-dimensional image generation method according to the present disclosure. In some implementations, the user terminal 110 may use a built-in application of the user terminal to perform the three-dimensional image generation method according to the present disclosure. In some other implementations, the user terminal 110 may perform the three-dimensional image generation method provided in the present disclosure by invoking an application stored externally on the user terminal.

In some other embodiments, the user terminal 110 transmits a received text prompt-to-be-processed to the server 130 via the network 120, and the server 130 performs the three-dimensional image generation method. In some implementations, the server 130 may perform the three-dimensional image generation method by using an application built in the server. In some other implementations, the server 130 may perform the three-dimensional image generation method by invoking an application stored externally to the server.

The network 120 may be a single network or a combination of at least two different networks. For example, the network 120 may include, but is not limited to, one or a combination of several of a local area network, a wide area network, a public network, and a private network. The server 130 may be an independent server, a server cluster or distributed system composed of a plurality of physical servers, or a cloud server that provides a basic cloud computing service such as a cloud service, a cloud database, cloud computing, a cloud function, cloud storage, a network service, cloud communication, a middleware service, a domain name service, a security service, a positioning service, as well as big data and an artificial intelligence platform. This embodiment of the present disclosure does not impose specific limitations on this.

The database 140 may refer to a device having a storage function. The database 140 is configured to store various data used, generated, and outputted during work of the user terminal 110 and the server 130. The database 140 may be local or remote. The database 140 may include various memories, such as a random access memory (RAM) and a read only memory (ROM). The storage devices mentioned above are non-limiting examples, and the storage devices that may be used in the system are not limited thereto. The database 140 may be connected to or communicate with the server 130 or a part thereof via the network 120, or be directly connected to or communicate with the server 130, or a combination of the foregoing two methods.

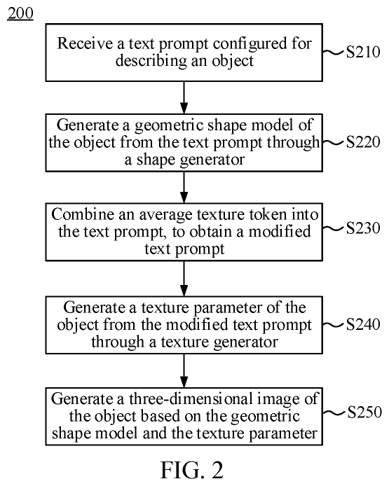

A three-dimensional image generation method according to an embodiment of the present disclosure is described below with reference to FIG. 2. FIG. 2 is a flowchart of a three-dimensional image generation method 200 according to an embodiment of the present disclosure. As described above, the three-dimensional image generation method 200 may be performed by a user terminal or a server. This embodiment of the present disclosure does not impose specific limitations on this. A three-dimensional image generation model configured to implement the three-dimensional image generation method according to this embodiment of the present disclosure may include a shape generator and a texture generator, which are further described below in this disclosure.

Operation S210: Receive a text prompt describing an object. In this embodiment of the present disclosure, a three-dimensional representation of any object may be generated, such as a three-dimensional avatar of a specified person or animal. This embodiment of the present disclosure does not impose specific limitations on this. The text prompt is a description of content, a style, or other aspects of an object for which a three-dimensional representation is to be generated. This embodiment of the present disclosure does not impose specific limitations on this. For example, if the object for which the three-dimensional representation is to be generated is a head of a specified person, the text prompt may include one or more of a name, an age, a gender, or an appearance of the person. In an example, if a user wants to generate a three-dimensional avatar of a person A, the user may input a text prompt “Person A”, or further input a text prompt “Person A, elderly”, or another suitable text prompt. In another example, if the user wants to generate a three-dimensional avatar of an animal B, the user may input a text prompt “Animal B”, or further input a text prompt “Animal B, yellow”, or another suitable text prompt.

Operation S220: Generate a geometric shape model of the object from the text prompt through a shape generator. Herein, the geometric shape model may refer to a three-dimensional representation including a geometric shape structure without texture information. In some embodiments, operation S220 includes: generating a shape parameter set from the text prompt through the shape generator; and generating the geometric shape model of the object from the shape parameter set. For example, the shape generator is used to generate the shape parameter set based on the text prompt, and the geometric shape model of the object is generated under a control of the shape parameter set. In an example, the shape generator according to this embodiment of the present disclosure may include a text encoder. The text encoder may encode the text prompt to generate a text embedding vector, and then generate a shape parameter set based on the text embedding vector. In this embodiment of the present disclosure, the text encoder may be constructed based on a related pre-training model, such as a contrastive language-image pre-training (CLIP) model. The CLIP model is pre-trained by using a large-scale text-image pair (for example, an image and a corresponding text description), to learn a matching relationship between a text and an image. The text embedding vector extracted by the CLIP model from the text prompt may be, for example, represented as 1=CLIP (T), where T represents the text prompt. The text encoder is described above by using the CLIP as an example, but this embodiment of the present disclosure is not limited thereto, and the text encoder may also be constructed by using another suitable pre-training model.

In some embodiments, the shape parameter set generated by the shape generator may represent a geometric shape of the object. In some embodiments, different from a commonly used implicit representation in a related neural network model, the shape parameter set generated by using the shape generator according to this embodiment of the present disclosure may be used to explicitly represent the geometric shape of the object based on a point cloud, a mesh, a voxel, or another representation, so that the shape parameter set may be directly used to generate the geometric shape model of the object, and may subsequently be directly used for animation. In addition, when the geometric shape model is generated based on the shape parameter set, a more precise geometric shape model may further be generated with reference to prior knowledge of the object. Taking the object being the head of a human or the head of an animal as an example, the geometric shape model may be generated under a control of the shape parameter set by using a three-dimensional deformation model having prior knowledge of a human or animal face shape, expression, and posture. In some embodiments, the shape generator may include the three-dimensional deformation model.

An example in which the three-dimensional deformation model is a FLAME model is used for description. FLAME is a statistical model configured to perform three-dimensional face reconstruction, is a linear shape space trained from 3800 human head scanning datasets, combines shape, expression, and posture changes, and may process corresponding parameters into a human head mesh and output 5023 mesh vertexes. When the object is a three-dimensional human head, the geometric shape model of the head may be generated by using the FLAME model under the control of the shape parameter set. Because the FLAME model integrates a large amount of facial prior knowledge, elements such as a skeletal structure and a facial expression may be effectively controlled, and a three-dimensional head model generated in this mode may have high fidelity.

Usually, the text embedding vector generated by the CLIP model has a high dimension, and the shape parameter set generated by the shape generator according to this embodiment of the present disclosure has a low dimension to be suitable for driving by using a prior model such as the FLAME model. Therefore, the shape generator according to this embodiment of the present disclosure may further include a multi-layer perception (MLP) block that performs dimension reduction on the text embedding vector, for projecting the text embedding vector to a shape parameter space, to generate a predicted shape parameter set. Using the CLIP model as an example, the predicted shape parameter set S may be represented as S=f (CLIP (T)), where f represents a mapping function of the multi-layer perception block.

Operation S230: Combine an average texture token into the text prompt, to obtain a modified text prompt. The average texture token represents common texture information of a category of the object. In an example, the average texture token represents the common texture information of the category or style to which the object belongs. For example, when the object is the head of a human or the head of an animal, the average texture token may represent one or more of a facial feature, a facial topological structure, or a facial texture coordinate mapping relationship shared by the human or the animal. The facial texture coordinate mapping relationship represents a mapping relationship between texture coordinates of the face and vertex coordinates of the geometric shape model of the head. According to an example of this embodiment of the present disclosure, the modified text prompt may be generated by adding the average texture token before or after the text prompt. This embodiment of the present disclosure does not specifically limit a specific modification mode.

Operation S240: Generate a texture parameter set of the object from the modified text prompt through a texture generator. The texture parameter set represents texture information of the object.

Operation S250: Generate a three-dimensional image of the object based on the geometric shape model and the texture parameter set. In some embodiments, by mapping texture information indicated by the texture parameter set to the geometric shape model generated based on the shape parameter set, the three-dimensional image with the texture information may be generated. For example, the texture parameter set may be a texture value represented by texture coordinates (e.g., UV coordinates), and each coordinate value is in a one-to-one correspondence with each vertex in the geometric shape model. Texture mapping is performed based on the correspondence, thereby generating the three-dimensional image with the texture information. The three-dimensional image is a representation of a three-dimensional model of the object, and may also be referred to as a three-dimensional representation or three-dimensional data. The texture generator according to this embodiment of the present disclosure may be constructed based on a related pre-training model. For example, the texture generator may include a stable diffusion model, but this embodiment of the present disclosure is not limited thereto, and another suitable pre-training model may also be used.

In this embodiment of the present disclosure, in addition to the text prompt pointing to a particular object, the average texture token is further introduced to represent average texture information of the category to which the object belongs, such as an average facial feature of the human head. A trained texture generator may learn the average texture information represented by the average texture token. Details are described in further detail below, and therefore a more accurate texture parameter set may be generated based on the text prompt modified by using the average texture token. In this embodiment of the present disclosure, the average texture token may be a special-character token, namely a token formed by special characters that are not natural language characters, such as “T\hat{ }*”, “#/”, and “¥%”. This embodiment of the present disclosure does not impose specific limitations on this. Compared with using the natural language characters, using the special-character token may reduce ambiguity caused by strong prior knowledge of the texture generator on a natural language during the training of the texture generator.

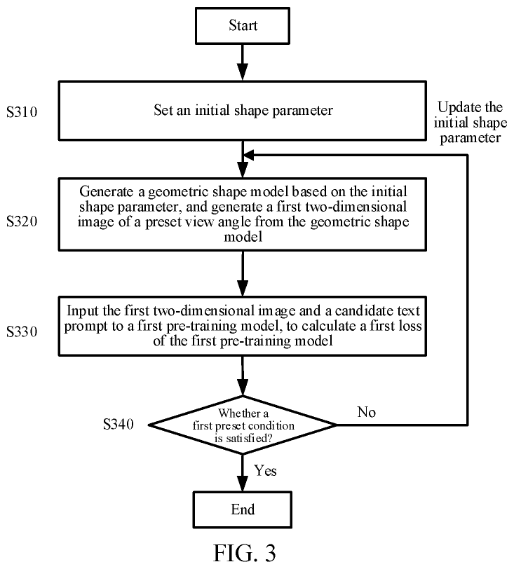

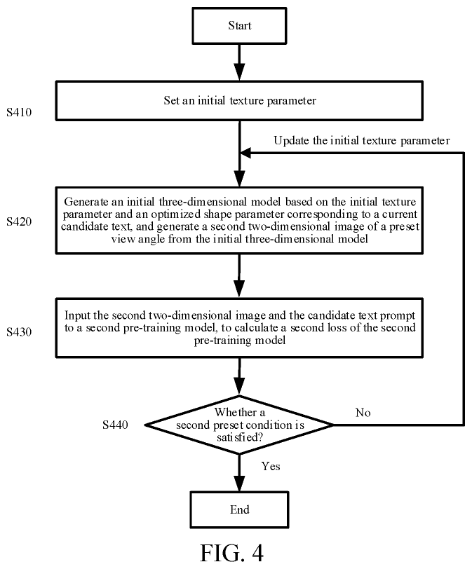

In this embodiment of the present disclosure, a data-free training method for the three-dimensional image generation model is provided. A large-scale training data set does not need to be manually collected. Instead, a training data set may be directly generated based on the pre-training model. In an example, a shape training data set for training the shape generator and a texture training data set for training the texture generator may be generated by training the pre-training model. A method for training a shape generator and a texture generator according to an embodiment of the present disclosure is described below with reference to FIG. 3 to FIG. 5. FIG. 3 is a flowchart of a method 300 for training a shape generator according to an embodiment of the present disclosure, FIG. 4 is a flowchart of a method 400 for training a texture generator according to an embodiment of the present disclosure, and FIG. 5 is a training data generation process according to an example of an embodiment of the present disclosure.

When training data is generated, a candidate text prompt set including a plurality of candidate text prompts may be prepared. As shown in FIG. 3, for each candidate text prompt in the candidate text prompt set, operation S310: set an initial shape parameter set. For example, the initial shape parameter set may be set to a sequence of all zeros. This embodiment of the present disclosure does not impose specific limitations on this. In an example of FIG. 5, generating a three-dimensional human avatar is used as an example for description. FIG. 5 shows an example text prompt “Person A”.

Operation S320: Generate a geometric shape model based on the initial shape parameter set, and generate a first two-dimensional image of a preset view angle from the geometric shape model. For example, the geometric shape model may be generated by using a model having prior knowledge of an object. In the example of FIG. 5, FLAME is used as an example for description. The initial shape parameter set is inputted to the FLAME model to generate the geometric shape model. Then, the first two-dimensional image of the preset view angle is generated from the geometric shape model. For example, a two-dimensional image of any view angle is clipped from a generated geometric shape model, and for ease of distinguishing, is referred to as the first two-dimensional image herein, as shown in FIG. 5.

Operation S330: Input the first two-dimensional image and a candidate text prompt to a first pre-training model, to calculate a first loss of the first pre-training model. Operation S340: Determine whether the first loss satisfies a first preset condition. When the first loss does not satisfy the first preset condition, the initial shape parameter set is updated based on the first loss, and the foregoing operation S320 to operation S340 are continuously performed until the first preset condition is satisfied, to generate a modified shape parameter set corresponding to the candidate text prompt. For example, the first preset condition is that the first loss is minimum or reaches a preset value, or reaches a preset iteration count. When the first preset condition is satisfied, iteratively performing operations S320 to S340 is stopped, and the modified shape parameter set corresponding to the candidate text prompt is outputted. In the example of FIG. 5, a stable diffusion model may be used for the first pre-training model, and the first loss may be a score distillation sampling (SDS) loss L_{SDS1}, namely a loss between random noise added to an image and noise predicted from the noise-added image in a diffusion process. In an example, the first loss L_{SDS1} may be calculated according to the following equation (1):

$${∇}_{θ} {ℒ}_{SDS} ( ϕ , x ) = {𝔼}_{t , ϵ} [ ω ( t ) ( {\hat{ϵ}}_{ϕ} ( {z}_{t} ; y , t ) - ϵ ) \frac{\partial z}{\partial x} \frac{\partial x}{\partial θ} ] \qquad ( 1 )$$

where φ represents a function for generating an image from text; x represents an inputted two-dimensional image sample; z is a latent feature map of the two-dimensional image sample in a latent space, and zₜ represents a noise-added version; y represents a text embedding vector; t represents a time step; ϵ represents added random noise; \hat{ϵ}_{φ}(zₜ; y, t) represents predicted noise; w (t) represents a weight; θ is a three-dimensional volume parameter; and ∇_{θ} represents a gradient of L_{SDS} for learnable parameters, and [symbol] represents an expected value.

In the foregoing equation (1), the predicted noise \hat{ϵ}_{φ}(zₜ; y, t) may be calculated according to the following equation (2):

$${\hat{ϵ}}_{ϕ} ( {z}_{t} ; y , t ) = ( 1 + {ω}_{e} ) {ϵ}_{ϕ} ( {z}_{t} ; y , t ) - {ω}_{e} {ϵ}_{ϕ} ( {z}_{t} ; t ) \qquad ( 2 )$$

where ϵ_{φ} represents a pre-trained denoising function, and wₑ is a ratio parameter introduced to improve sample fidelity and balance diversity of generated samples. In a related technology, the ratio parameter wₑ is usually set to a high value, to enhance a text control capability and improve sample fidelity, but this comes at the expense of sample diversity. In this embodiment of the present disclosure, due to the utilization of the strong prior knowledge provided by models such as the FLAME model in the foregoing process, the ratio parameter wₑ may be set to a low value, to help ensure sample fidelity without loss of sample diversity.

Through the method shown in FIG. 3, the modified shape parameter set corresponding to each candidate text prompt in the candidate text prompt set may be generated, and these text prompt-modified shape parameter set pairs may be used for training the shape generator. For example, the shape training data set for training the shape generator may include a plurality of training text prompts selected from the candidate text prompt set and a plurality of corresponding modified shape parameter sets. Although the process of generating the shape training data set is described in FIG. 5 by using the stable diffusion model as an example, the present disclosure is not limited thereto, and any other suitable pre-training model may also be used to generate the shape training data set.

Based on the shape training data set that includes the modified shape parameter sets and that is generated according to the method in FIG. 3, reference may be further made to the method shown in FIG. 4 to generate the texture training data set. As shown in FIG. 4, for each candidate text prompt in the candidate text prompt set, operation S410: set an initial texture parameter set. Herein, the initial texture parameter set may use, for example, an average texture parameter extracted from a plurality of real three-dimensional representations. For example, when the object is a human head, the average texture parameter may be extracted from three-dimensional representations of a plurality of real heads, to be used as the initial texture parameter set herein. Alternatively, the initial texture parameter set may directly use a common texture parameter in an existing three-dimensional deformation model such as FLAME, for example a general UV map shown in an example in FIG. 5. In other words, the initial texture parameter set may be represented as ψ=ψ₀+Δψ, where ψ₀ represents the average texture parameter extracted from the real three-dimensional representation or the general texture parameter provided by FLAME or a similar model, Av represents an object-specific texture detail, with an initial value set to 0, and Δψ is expected to be continuously optimized through the training process to represent personalized texture information.

Operation S420: Generate an initial three-dimensional model based on the initial texture parameter set and a modified shape parameter set corresponding to a current candidate text, and generate a second two-dimensional image of a preset view angle from the initial three-dimensional model. For example, a geometric shape model may be generated first based on the modified shape parameter set, and then the initial texture parameter set is mapped to the geometric shape model to generate the initial three-dimensional model. Then, a two-dimensional image of a preset view angle is generated from a generated initial three-dimensional model, and for ease of distinguishing, is referred to as the second two-dimensional image herein, as shown in FIG. 5.

Operation S430: Input the second two-dimensional image and the candidate text prompt to a second pre-training model, to calculate a second loss of the second pre-training model. Operation S440: Determine whether the second loss satisfies a second preset condition. When the second preset condition is not satisfied, the initial texture parameter set is updated based on the second loss, and the foregoing operations S420 to S440 are continuously performed until the second preset condition is satisfied. For example, the second preset condition is that the second loss is minimum or reaches a preset value, or reaches a preset iteration count. When the second preset condition is satisfied, the iteration is stopped, and the modified texture parameter set corresponding to the candidate text prompt is outputted. In the example of FIG. 5, a stable diffusion model may also be used for the second pre-training model, and the second loss may be an SDS loss L_{SDS2}, namely a loss between random noise added to an image and noise predicted from the noise-added image in a diffusion process. For example, the second loss L_{SDS2} may be calculated according to the foregoing equation (1).

Through the method shown in FIG. 5, the modified texture parameter set corresponding to each candidate text prompt in the candidate text prompt set may be generated, and these text prompt-modified texture parameter set pairs may be used for training the texture generator. For example, the texture training data set for training the texture generator may include a plurality of training text prompts selected above and a plurality of corresponding modified texture parameter sets. Although the process of generating the texture training data set is described in FIG. 5 by using the stable diffusion model as an example, the present disclosure is not limited thereto, and any other suitable pre-training model may also be used to generate the texture training data set.

The process of generating the shape training data set and the texture training data set through the training of the pre-training model such as the stable diffusion model is described above. The three-dimensional image generation model according to this embodiment of the present disclosure does not require the collection of the large-scale training data set during training. Instead, any number of training data may be generated through this process, thereby reducing data costs required for training and simplifying the training process.

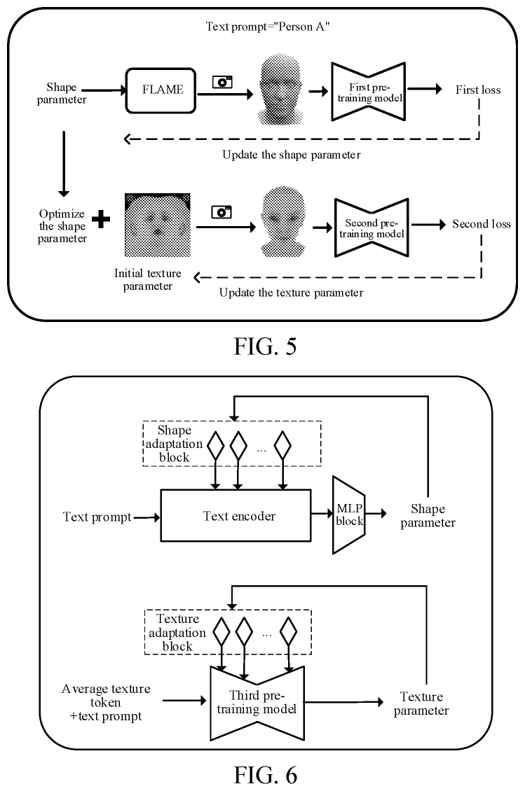

A process of training a shape generator and a texture generator according to an embodiment of the present disclosure is described below with reference to FIG. 6. FIG. 6 is a process of training a shape generator and a texture generator according to an embodiment of the present disclosure. The shape generator includes a text encoder and an MLP block that are constructed based on a pre-training model, and the texture generator may also be constructed based on the pre-training model. Herein, to distinguish from the first pre-training model and the second pre-training model configured to generate the training data above, the pre-training model of the texture generator is referred to as a third pre-training model, and may be, for example, a stable diffusion model.

When the shape generator is trained, each training text prompt in the shape training data set and a corresponding modified shape parameter set may be used as ground truth to train the shape generator in a model fine-tuning mode. In this embodiment of the present disclosure, the text encoder of the shape generator is constructed based on the pre-training model. For example, the text encoder may include a CLIP model. Because the pre-training model such as the CLIP is pre-trained by using large-scale text-image pairs (for example, an image and a corresponding text description), the shape generator may be tuned (e.g., fine-tuned) to be applicable to generating a shape parameter set according to this embodiment of the present disclosure. To implement tuning (e.g., fine-tuning) of the shape generator, as shown in FIG. 6, the shape generator according to this embodiment of the present disclosure may further include a shape adaptation block, configured to convert training of a high-dimensional parameter matrix of the text encoder such as the CLIP into fine-tuning through the shape adaptation block.

According to an example of this embodiment of the present disclosure, the shape generator may be tuned in a mode of a large language model low-rank adaption (LoRA). However, this is an example and not a limitation, and another proper fine-tuning mode may also be used, such as efficient parameter fine-tuning or prompt fine-tuning. A basic principle of the LoRA is to add a “side branch” to an original model. The side branch decomposes a high-dimensional matrix into two low-rank matrices, and the two low-rank matrices are trained during training, thereby reducing the number of training parameters and improving a training speed. In the case of fine-tuning using the LoRA, assuming a dimension of a text embedding vector outputted by the text encoder is d*d, the shape adaptation block may decompose a matrix with the d*d dimension into a d*r matrix and an r*d matrix, where r is much smaller than d. During training, the d*r matrix and the r*d matrix are trained, thereby achieving low-parameter fine-tuning of a large model.

The shape generator trained in a fine-tuning mode may generate a shape parameter set with expected characteristics based on an inputted text prompt, and may explicitly represent a geometric shape of an object through a point cloud, a mesh, or a voxel, and therefore may be directly used to generate a geometric shape model. For example, the FLAME model may be directly used to generate the geometric shape model. Compared with an implicit representation in which the geometric shape may be represented by using a neural network for further processing, the shape generator is more suitable for an animation purpose.

A mode of training the texture generator is similar to that of the shape generator. A difference lies in that: for each training text prompt in a texture training data set, an average texture token is combined into the text prompt, to obtain a modified text prompt, and then the modified training text prompt and a corresponding modified texture parameter set are used as ground truth for training the texture generator. As described above, a purpose of the average texture token is to represent average texture information of a category to which the object belongs. Through training, the texture generator may learn expected average texture information included in the average texture token. In this embodiment of the present disclosure, the average texture token may be a special-character token formed by special characters, such as “T*”.

Similarly, the texture generator is also trained by using the model fine-tuning mode. In this embodiment of the present disclosure, the third pre-training model of the texture generator may be, for example, the stable diffusion model. Because the third pre-training model such as the stable diffusion model is pre-trained by using large-scale text-image pairs (for example, an image and a corresponding text description), the texture generator may be fine-tuned to be applicable to generating a texture parameter set according to this embodiment of the present disclosure. To implement fine-tuning of the texture generator, as shown in FIG. 6, the texture generator according to this embodiment of the present disclosure may further include a texture adaptation block, configured to convert training of a high-dimensional parameter matrix of the third pre-training model such as the stable diffusion model into fine-tuning through the texture adaptation block. According to the example of this embodiment of the present disclosure, the LoRA mode may be used to perform fine-tuning on the texture generator. However, this is an example and not a limitation, and another proper fine-tuning mode may also be used, such as efficient parameter fine-tuning or prompt fine-tuning.

The texture generator trained in the fine-tuning mode may learn the average texture information included in the average texture token, so as to generate a high-quality texture parameter set based on a text prompt pointing to a particular object and the average texture token, which may reflect average texture information of a category to which the object belongs, such as a facial feature, a facial topological structure, or a facial UV mapping relationship shared by humans, and may represent a personalized texture feature of the particular object. In one example, the object is a head of a human, and the average texture token corresponds to one or more of a facial feature, a facial topological structure, or a facial texture coordinate mapping relationship shared by a category of humans. In another example, the object is a head of an animal, and the average texture token corresponds to one or more of a facial feature, a facial topological structure, or a facial texture coordinate mapping relationship shared by a category of animals.

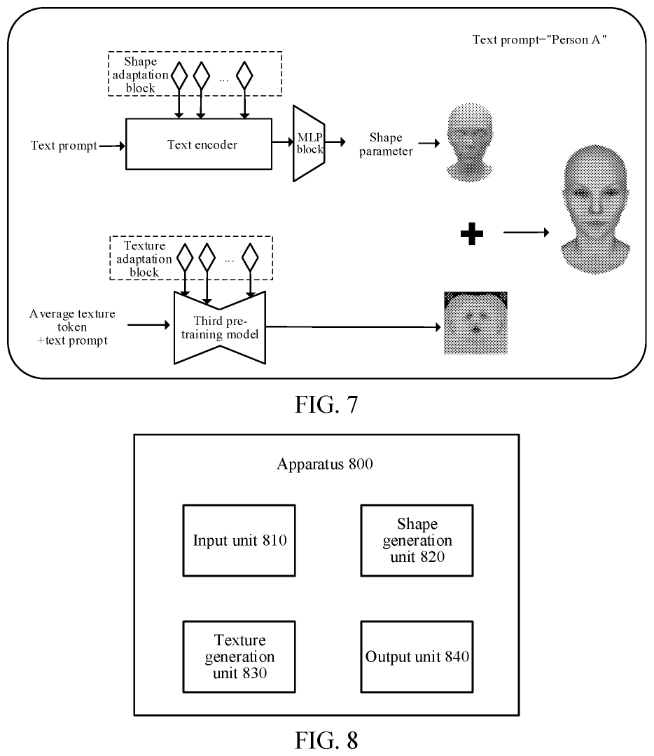

The process of training the shape generator and the texture generator of the three-dimensional image generation model according to this embodiment of the present disclosure is described above. The trained three-dimensional image generation model may generate a three-dimensional image of the object based on the inputted text prompt, such as outputting a three-dimensional head model based on an inputted person name. FIG. 7 is a schematic processing process of a three-dimensional image generation model according to an example of an embodiment of the present disclosure. In this example, generating a three-dimensional avatar of a specified person is used as an example for description. As shown in FIG. 7, for example, a text prompt “Person A” may be inputted into the three-dimensional image generation model. A shape generator encodes the text prompt by using a text encoder to generate a text embedding vector, and performs dimension reduction on the text embedding vector by using an MLP block, to generate a shape parameter set. The shape parameter set may be used to generate a geometric shape model by using a model with prior knowledge such as the FLAME model. On the other hand, the text prompt is modified by using an average texture token. For example, the average texture token may be simply added before the text prompt, and a third pre-training model of a texture generator processes the modified text prompt to output a texture parameter set. The geometric shape model and the texture parameter set are combined. For example, the texture parameter set is mapped to the geometric shape model, so that a three-dimensional image may be generated, as shown in FIG. 7.

By using the three-dimensional image generation method according to this embodiment of the present disclosure, the shape generator and the texture generator of the three-dimensional image generation model are trained by using a data-free training method, thereby reducing data costs required for training and simplifying the training process. In the training process of the shape generator according to this embodiment of the present disclosure, a three-dimensional deformation model with prior knowledge of a three-dimensional object, such as the FLAME model is used. The trained shape generator may generate the shape parameter set that may explicitly represent a geometric shape. The shape parameter set may be directly driven by the three-dimensional deformation model such as the FLAME model, for controlling an element such as a skeletal structure or a facial expression more effectively. Compared with a related method relying on the implicit representation, the trained shape generator is more suitable for the animation purpose. In addition, because the shape generator according to this embodiment of the present disclosure uses a generalized shape generation model rather than an identity-specific model, three-dimensional images of various objects may be efficiently generated without optimizing the objects one by one during testing, thereby improving a model inference speed. On the other hand, the average texture token is introduced in this embodiment of the present disclosure to supplement the text prompt, which may encapsulate average texture information of important three-dimensional objects (e.g., a facial texture feature shared by humans), thereby helping generate a higher-quality three-dimensional image.

Compared with a related model, the three-dimensional image generation method according to this embodiment of the present disclosure may stably and rapidly generate a higher-quality three-dimensional image, and the generated three-dimensional avatar may be conveniently used to generate a continuous and natural animation. The method is especially applicable to generating a human or animal three-dimensional avatar, and may be applied to three-dimensional modeling and animation production in fields such as games, audiovisual media, and wearable devices. By using an example in which the shape generator according to this embodiment of the present disclosure uses a CLIP encoder, quantitative results of the three-dimensional image generation model provided in the present disclosure and some related models under the same parameter setting conditions are compared, and the results are shown in Table 1 below. A CLIP score represents fidelity of a generated image. A higher CLIP score indicates better image quality. As illustrated in Table 1, the three-dimensional image generation model according to this embodiment of the present disclosure has the highest CLIP score and the highest inference speed, which demonstrates the effectiveness of the three-dimensional image generation model provided in the present disclosure.

TABLE 1
Comparison of quantitative results of the three-
dimensional image generation model according to
the present disclosure and some related models

| | CLIP | |
|---|---|---|
| Model | score | Inference speed |
| Text2Mesh | 0.2109 | Approximately 15 minutes |
| AvatarCLIP | 0.2109 | Approximately 5 hours |
| Stable-DreamFusion | 0.2594 | Approximately 2.5 hours |
| DreamFace | 0.2934 | Approximately 5 minutes |
| Model of the present disclosure | 0.3161 | Approximately 1 minute |

A three-dimensional image generation apparatus according to an embodiment of the present disclosure is described below with reference to FIG. 8. FIG. 8 is a schematic structural diagram of a three-dimensional image generation apparatus 800 according to an embodiment of the present disclosure. As shown in FIG. 8, the three-dimensional image generation apparatus 800 includes an input unit 810, a shape generation unit 820, a texture generation unit 830, and an output unit 840. In addition to the four units, the apparatus 800 may further include other related components. However, because the components are irrelevant to the content of the present disclosure, detailed descriptions of specific content of the components are omitted herein. In addition, since details of some functions of the apparatus 800 are similar to those of the operations in the method 200 described with reference to FIG. 2, repetitive descriptions of partial content are omitted herein for the sake of brevity. The apparatus 800 according to this embodiment of the present disclosure may be implemented as a terminal or a server, as described above with reference to FIG. 1.

The input unit 810 is configured to receive a text prompt describing an object. In this embodiment of the present disclosure, a target three-dimensional image may be a three-dimensional image of any object that a user expects to generate, such as a three-dimensional avatar of a specified person or animal. This embodiment of the present disclosure does not impose specific limitations on this. The text prompt is a description about content, a style, or other aspects of the target three-dimensional image. This embodiment of the present disclosure does not impose specific limitations on this. For example, if the target three-dimensional object is a three-dimensional image of a specified person, the text prompt may include one or more of a name, an age, a gender, or an appearance of the person. In an example, if the user wants to generate a three-dimensional avatar of a person A, the user may input, by the input unit 810, a text prompt “Person A”, or further input a text prompt “Person A, elderly”, or another suitable prompt. In another example, if the user wants to generate a three-dimensional avatar of an animal B, the user may input, by the input unit 810, a text prompt “Animal B”, or further input a text prompt “Animal B, yellow”, or another suitable prompt.

The shape generation unit 820 is configured to generate a geometric shape model of the object from the text prompt through a shape generator. Herein, the geometric shape model may refer to a three-dimensional representation that includes geometric shape information without texture information. In an example, the shape generator according to this embodiment of the present disclosure may include a text encoder. The text encoder may encode the text prompt to generate a text embedding vector, and then generate a shape parameter set based on the text embedding vector. In this embodiment of the present disclosure, the text encoder may be constructed based on a related pre-training model, such as a contrastive language-image pre-training (CLIP) model. The CLIP model is pre-trained by using a large-scale text-image pair (for example, an image and a corresponding text description), to learn a matching relationship between a text and an image. The text embedding vector extracted by the CLIP model from the text prompt may be, for example, represented as 1=CLIP (T), where T represents the text prompt. The text encoder is described above by using the CLIP as an example, but this embodiment of the present disclosure is not limited thereto, and the text encoder may also be constructed by using another suitable pre-training model.

Different from a commonly used implicit representation in a related neural network model, the shape parameter set generated by using the shape generator according to this embodiment of the present disclosure may be used to explicitly represent a geometric shape of the object based on a point cloud, a mesh, a voxel, or another representation, so that the shape parameter set may be directly used to generate the geometric shape model, and may subsequently be directly used for animation. In addition, when the geometric shape model is generated based on the shape parameter set, a more precise geometric shape model may further be generated with reference to prior knowledge of the object. Taking the object being the head of a human or the head of an animal as an example, the geometric shape model of the target three-dimensional image may be generated under the control of the shape parameter set by using a three-dimensional deformation model having prior knowledge of a human or animal face shape, expression, and posture.

A FLAME model is used as an example for description. FLAME is a statistical model configured to perform three-dimensional face reconstruction, is a linear shape space trained from 3800 human head scanning datasets, combines shape, expression, and posture changes, and may process corresponding parameters into a human head mesh and output 5023 mesh vertexes. When the target three-dimensional image is a three-dimensional human avatar, a geometric shape model of the three-dimensional avatar may be generated by using the FLAME model under the control of the shape parameter set. Because the FLAME model integrates a large amount of facial prior knowledge, elements such as a skeletal structure and a facial expression may be effectively controlled, and the three-dimensional avatar generated in this mode has high fidelity.

Usually, the text embedding vector generated by the CLIP model has a high dimension, and the shape parameter set generated by the shape generator according to this embodiment of the present disclosure has a low dimension to be suitable for driving by using a prior model such as the FLAME model. Therefore, the shape generator according to this embodiment of the present disclosure may further include a multi-layer perception (MLP) block that performs dimension reduction on the text embedding vector, for projecting the text embedding vector to a shape parameter space, to generate a predicted shape parameter set. Using the CLIP model as an example, the predicted shape parameter set S may be represented as S=f (CLIP(T)), where f represents a mapping function of the multi-layer perception block.

The texture generation unit 830 is configured to combine an average texture token into the text prompt, to obtain a modified text prompt, the average texture token representing common texture information of a category of the object. In an aspect, the average texture token may represent average texture information of the category to which the object belongs. For example, when the category of the object is a human or animal, the average texture token may represent one or more of a facial feature, a facial topological structure, or a facial texture coordinate mapping relationship shared by the human or the animal. According to an example of this embodiment of the present disclosure, the modified text prompt may be generated by adding the average texture token before or after the text prompt. This embodiment of the present disclosure does not specifically limit a specific modification mode.

Then, the texture generation unit 830 generates a texture parameter set of the object from the modified text prompt through a texture generator, the texture parameter set representing texture information of the target three-dimensional image. The output unit 840 is configured to generate a three-dimensional image of the object based on the geometric shape model and the texture parameter set. For example, by mapping the texture parameter set to the geometric shape model generated based on the shape parameter set, the three-dimensional image with the texture information is generated, and the three-dimensional image is outputted. For example, the texture parameter set may be a texture value represented by texture coordinates (e.g., UV coordinates), and each coordinate value is in a one-to-one correspondence with each vertex in the geometric shape model. Texture mapping is performed based on the correspondence, thereby generating the three-dimensional image with the texture information. The texture generator according to this embodiment of the present disclosure may be constructed based on a related pre-training model, such as a stable diffusion model, but this embodiment of the present disclosure is not limited thereto, and another suitable pre-training model may also be used.

In this embodiment of the present disclosure, in addition to the text prompt pointing to a particular object, the average texture token is further introduced to represent average texture information of the category to which the object belongs, such as an average facial feature of the human head. A trained texture generator may learn the average texture information represented by the average texture token, which as described in further detail above, and therefore may generate a more accurate texture parameter set based on the text prompt modified by using the average texture token. In this embodiment of the present disclosure, the average texture token may be a special-character token, namely a token formed by special characters that are not natural language characters, such as “T\hat{ }*”, “#/”, and “¥%”. This embodiment of the present disclosure does not impose specific limitations on this. Compared with using the natural language characters, using the special-character token may reduce ambiguity caused by strong prior knowledge of the texture generator on a natural language during the training of the texture generator.

A data-free training method is provided based on the three-dimensional image generation apparatus 800 according to this embodiment of the present disclosure. A shape training data set for training a shape generator and a texture training data set for training a texture generator may be generated based on training of an existing pre-training model. Details are as described above with reference to FIG. 3 to FIG. 5, and details are not described herein again. After the shape training data set and the texture training data set are obtained, the shape generator and the texture generator may be trained in a large model fine-tuning mode by using the method described above with reference to FIG. 6, and details are not described herein again.

By using the three-dimensional image generation apparatus according to this embodiment of the present disclosure, the shape generator and the texture generator of the three-dimensional image generation model are trained by using the data-free training method, thereby reducing data costs required for training and simplifying a training process. In the training process of the shape generator according to this embodiment of the present disclosure, the three-dimensional deformation model with prior knowledge of a three-dimensional object, such as the FLAME model is used. The trained shape generator may generate the shape parameter set that may explicitly represent geometric shape information. The shape parameter set may be directly driven by the three-dimensional deformation model such as the FLAME, for controlling an element such as a skeletal structure or a facial expression more effectively. Compared with a related method relying on the implicit representation, the three-dimensional deformation model is more suitable for an animation purpose. In addition, because the shape generator according to this embodiment of the present disclosure uses a generalized shape generation model rather than an identity-specific model, three-dimensional images of various objects may be efficiently generated without optimizing the objects one by one during testing, thereby improving a model inference speed. On the other hand, the average texture token is introduced in this embodiment of the present disclosure to supplement the text prompt, which may encapsulate average texture information of important three-dimensional objects (e.g., a facial texture feature shared by humans), thereby helping generate a higher-quality three-dimensional image.

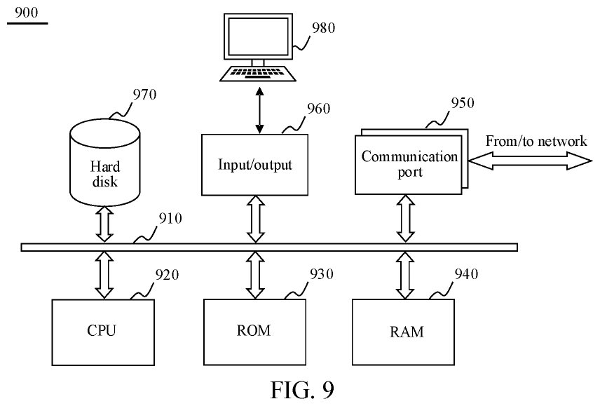

In addition, a device (e.g., a three-dimensional image generation device) according to an embodiment of the present disclosure may also be implemented with the help of an architecture of a computing device shown in FIG. 9. FIG. 9 is a schematic diagram of an architecture of a computing device according to an embodiment of the present disclosure. As shown in FIG. 9, the computing device 900 may include a bus 910, one or more CPUs 920, a read-only memory (ROM) 930, a random access memory (RAM) 940, a communication port 950 connected to a network, an input/output component 960, a hard disk 970, and the like. A storage device in the computing device 900 such as the ROM 930 or the hard disk 970 may store various data or files used for computer processing and/or communication and program instructions executed by the CPU. The computing device 900 may further include a user interface 980. The architecture shown in FIG. 9 is an example. When implementing different devices, one or more components in the computing device shown in FIG. 9 may be omitted according to an actual need. The device according to this embodiment of the present disclosure may be configured to perform the three-dimensional image generation method according to the foregoing embodiments of the present disclosure, or be configured to implement the three-dimensional image generation apparatus according to the foregoing embodiments of the present disclosure.

The embodiments of the present disclosure may alternatively be implemented as a computer-readable storage medium (e.g., a non-transitory computer-readable storage medium). The computer-readable storage medium according to this embodiment of the present disclosure has instructions stored therein. The instructions, when executed by processing circuitry (e.g., a processor), causes the three-dimensional image generation method according to the embodiments of the present disclosure described with reference to the foregoing accompanying drawings to be performed. The computer-readable storage medium includes, but is not limited to, for example, a volatile memory and/or a non-volatile memory. For example, the volatile memory may include a random access memory (RAM) and/or a cache. For example, the non-volatile memory may include a read-only memory (ROM), a hard disk, or a flash memory.

According to an embodiment of the present disclosure, a computer program product or a computer program is further provided. The computer program product or the computer program includes computer-readable instructions, and the instructions may be stored in a non-transitory computer-readable storage medium. The processing circuitry (e.g., a processor) of the computer device reads the instructions from the non-transitory computer-readable storage medium, and the processing circuitry (e.g., the processor) executes the instructions, thereby allowing the computer device to perform the three-dimensional image generation method described in any one of the foregoing embodiments.

A program part in the technology may be considered as a “product” or “article” that exists in a form of executable code and/or related data, and is involved in or implemented through the computer-readable medium. The tangible and permanent storage medium may include an internal memory or a memory used by any computer, processor, or similar device or related module, such as various semiconductor memories, tape drives, disk drives, or any similar device that may provide a storage function for software.

All software or a part thereof may sometimes communicate through a network, such as the Internet or another communications network. Such communication may enable the loading of the software from one computer device or processor to another. Therefore, another medium capable of transmitting a software element may also be used as a physical connection between local devices. For example, an optical wave, an electric wave, or an electromagnetic wave is transmitted through a cable, an optical cable, air, or similar media. A physical medium used for carrier waves, such as a cable, a wireless connection, an optical cable, or a similar device may also be considered as a medium for carrying the software. Unless the usage herein limits a tangible “storage” medium, other terms representing a computer or machine “readable medium” represent a medium participating in a process of executing any instruction by the processor.

Specific words are used in this disclosure to describe one or more embodiments of this disclosure. For example, “the first/second embodiment”, “an embodiment”, and/or “some embodiments” mean a feature, structure, or characteristic related to at least one embodiment of this disclosure. Therefore, “an embodiment” or “one embodiment” or “an alternative embodiment” mentioned twice or more times at different positions in this disclosure does not necessarily refer to the same embodiment. In addition, some features, structures, or characteristics in one or more embodiments of this disclosure may be properly combined.

In addition, those skilled in the art may understand that, various aspects of this disclosure may be illustrated and described by using several types or situations with patentability, including any new and useful process, machine, product, or combination of materials, or any new and useful improvement thereof. Correspondingly, various aspects of this disclosure may be executed by hardware, may be executed by software (including firmware, resident software, microcode, etc.), or may be executed by a combination of hardware and software. The foregoing hardware or software may be referred to as “data block”, “module”, “engine”, “unit”, “component” or “system”. In addition, various aspects of this disclosure may be embodied as computer products located in one or more computer-readable media, the product including computer-readable program code.

Unless otherwise defined, all terms (including technical and scientific terms) used herein have the same meaning as commonly understood by those of ordinary skill in the art to which the present disclosure belongs. The terms such as those defined in commonly used dictionaries are to be interpreted as having meanings that are consistent with the meanings in the context of the related art, and are not to be interpreted in an idealized or extremely formalized sense, unless expressively so defined herein.

The above is a description of the present disclosure, and is not to be considered as a limitation to the present disclosure. Although several embodiments of the present disclosure are described, those skilled in the art should understand that many modifications may be made to one or more embodiments described in this disclosure without departing from the present disclosure. Therefore, all these modifications are intended to be included within the scope of the present disclosure.

What is claimed is:

1. A three-dimensional image generation method, the method comprising:
receiving a text prompt describing an object;
generating a geometric shape model of the object based on the text prompt through a shape generator;
obtaining a modified text prompt based on a combination of an average texture token and the text prompt, the average texture token corresponding to common texture information of a category of the object;
generating a texture parameter set of the object based on the modified text prompt through a texture generator; and
generating, by processing circuitry, a three-dimensional image of the object based on mapping texture information indicated by the texture parameter set to the geometric shape model.

2. The method according to claim 1, wherein
the object is a head of a human, and the average texture token corresponds to one or more of a facial feature, a facial topological structure, or a facial texture coordinate mapping relationship shared by a category of humans; or
the object is a head of an animal, and the average texture token corresponds to one or more of a facial feature, a facial topological structure, or a facial texture coordinate mapping relationship shared by a category of animals.

3. The method according to claim 1, wherein the generating the geometric shape model of the object comprises:
generating a shape parameter set from the text prompt through the shape generator; and
generating the geometric shape model of the object based on the shape parameter set.

4. The method according to claim 3, wherein the generating the shape parameter set comprises:
performing text encoding on the text prompt to generate a text embedding vector; and
performing dimension reduction processing on the text embedding vector, to generate the shape parameter set.

5. The method according to claim 3, wherein the shape parameter set indicates a geometric shape of the object.

6. The method according to claim 1, wherein
the shape generator is trained based on a shape training data set;
the texture generator is trained based on a texture training data set; and
the shape training data set and the texture training data set are obtained based on training a pre-training model.

7. The method according to claim 6, wherein
the shape training data set includes a plurality of training text prompts selected from a candidate text prompt set and a plurality of corresponding modified shape parameter sets; and
the shape training data set is generated based on, for each candidate text prompt in the candidate text prompt set,
setting of an initial shape parameter set;
generation of a geometric shape model based on the initial shape parameter set;
generation of a first two-dimensional image of a first preset view angle from the geometric shape model;
inputting of the first two-dimensional image and the candidate text prompt to a first pre-training model, to calculate a first loss of the first pre-training model; and
updating of the initial shape parameter set based on the first loss, to generate a modified shape parameter set corresponding to the candidate text prompt.

8. The method according to claim 7, wherein
the texture training data set includes the plurality of training text prompts selected and a plurality of corresponding modified texture parameters; and
the texture training data set is generated based on, for each candidate text prompt in the candidate text prompt set,
setting of an initial texture parameter set;
generation of an initial three-dimensional model based on the initial texture parameter set and the modified shape parameter corresponding to the candidate text prompt;
generation of a second two-dimensional image of a second preset view angle from the initial three-dimensional model;
inputting of the second two-dimensional image and the candidate text prompt to a second pre-training model, to calculate a second loss of the second pre-training model; and
updating of the initial texture parameter set based on the second loss, to generate a modified texture parameter set corresponding to the candidate text prompt.

9. The method according to claim 8, wherein
the shape generator is trained based on tuning the shape generator based on each training text prompt in the shape training data set and the corresponding modified shape parameter set; and
the texture generator is trained based on:
combination, for each training text prompt in the texture training data set, of the average texture token and the training text prompt, to generate a modified training text prompt; and
tuning of the texture generator based on each modified training text prompt and the corresponding modified texture parameter set.

10. The method according to claim 1, wherein
the shape generator includes a text encoder, a multi-layer perception block configured to perform dimension reduction, and a shape adaptation block configured to perform model fine-tuning; and
the texture generator includes a third pre-training model and a texture adaptation block configured to perform model tuning.

11. The method according to claim 1, wherein the average texture token is a token formed by special characters that are not natural language characters.

12. The method according to claim 3, wherein
the object is a head of a human or a head of an animal; and
the generating the geometric shape model of the object based on the shape parameter set includes:
generating the geometric shape model, under control of the shape parameter, from a three-dimensional deformation model that is implemented based on prior knowledge of face shape, expression, or posture of a category of humans or a category of animals.

13. An electronic device, comprising:
processing circuitry configured to:
receive a text prompt describing an object;
generate a geometric shape model of the object based on the text prompt through a shape generator;
obtain a modified text prompt based on a combination of an average texture token and the text prompt, the average texture token corresponding to common texture information of a category of the object;
generate a texture parameter set of the object based on the modified text prompt through a texture generator; and
generate a three-dimensional image of the object based on mapping texture information indicated by the texture parameter set to the geometric shape model.

14. The electronic device according to claim 13, wherein the processing circuitry is configured to:
generate a shape parameter set from the text prompt through the shape generator; and
generate the geometric shape model of the object based on the shape parameter set.

15. The electronic device according to claim 13, wherein the average texture token is a token formed by special characters that are not natural language characters.

16. The electronic device according to claim 13, wherein
the shape generator is trained based on a shape training data set;
the texture generator is trained based on a texture training data set; and
the shape training data set and the texture training data set are obtained based on training a pre-training model.

17. The electronic device according to claim 16, wherein
the shape training data set includes a plurality of training text prompts selected from a candidate text prompt set and a plurality of corresponding modified shape parameter sets; and
the shape training data set is generated based on, for each candidate text prompt in the candidate text prompt set,
setting of an initial shape parameter set;
generation of a geometric shape model based on the initial shape parameter set;
generation of a first two-dimensional image of a first preset view angle from the geometric shape model;
inputting of the first two-dimensional image and the candidate text prompt to a first pre-training model, to calculate a first loss of the first pre-training model; and
updating of the initial shape parameter set based on the first loss, to generate a modified shape parameter set corresponding to the candidate text prompt.

18. The electronic device according to claim 17, wherein
the texture training data set includes the plurality of training text prompts selected and a plurality of corresponding modified texture parameters; and
the texture training data set is generated based on, for each candidate text prompt in the candidate text prompt set,
setting of an initial texture parameter set;
generation of an initial three-dimensional model based on the initial texture parameter set and the modified shape parameter corresponding to the candidate text prompt;
generation of a second two-dimensional image of a second preset view angle from the initial three-dimensional model;
inputting of the second two-dimensional image and the candidate text prompt to a second pre-training model, to calculate a second loss of the second pre-training model; and
updating of the initial texture parameter set based on the second loss, to generate a modified texture parameter set corresponding to the candidate text prompt.

19. The electronic device according to claim 18, wherein
the shape generator is trained based on tuning the shape generator based on each training text prompt in the shape training data set and the corresponding modified shape parameter set; and
the texture generator is trained based on:
combination, for each training text prompt in the texture training data set, of the average texture token and the training text prompt, to generate a modified training text prompt; and
tuning of the texture generator based on each modified training text prompt and the corresponding modified texture parameter set.

20. A non-transitory computer-readable storage medium storing instructions, which when executed by a processor, cause the processor to perform a three-dimensional image generation method, the method comprising:
receiving a text prompt describing an object;
generating a geometric shape model of the object based on the text prompt through a shape generator;
obtaining a modified text prompt based on a combination of an average texture token and the text prompt, the average texture token corresponding to common texture information of a category of the object;
generating a texture parameter set of the object based on the modified text prompt through a texture generator; and
generating a three-dimensional image of the object based on mapping texture information indicated by the texture parameter set to the geometric shape model.
